(19) United States
(12) Patent Application Publication
(10) Pub. No.: US 2009/0204421 A1
(43) Pub. Date: Aug. 13, 2009

(54) ELECTRONIC HEALTH RECORD TOUCH SCREEN FORM ENTRY METHOD

(75) Inventor: Manuel Jorge Vaz da Cunha Guimaraes, Braga (PT)

Correspondence Address: ABELMAN, FRAYNE & SCHWAB, 666 THIRD AVENUE, 10TH FLOOR, NEW YORK, NY, 10017, US

(73) Assignee: ALERT LIFE SCIENCES COMPUTING S.A., Porto (PT)

(21) Appl. No.: 11/927,201

(22) Filed: Oct. 29, 2007

(51) Int. Cl. G06Q 50/00; G06F 3/048

(52) U.S. Cl. 705/2; 715/841

(57) ABSTRACT

A computer implemented system and method allow users to create and edit electronic health records with the use of touch screen monitors, such that complex forms are managed by a user-friendly graphic user interface. The graphic user interface includes collapsible menus that enable the management of the complex hierarchical structure of the forms. The graphic user interface also includes a system that allows for three different values, corresponding to a positive value, a negative value and the deactivation of the data field, to be entered in the same location within the electronic form. The data elements of each data field are coded with recourse to standard medical terminologies enabling dynamic interaction and intelligent prompting.

### NOTICE OF COPYRIGHT AND AUTHORIZATION OF REPRODUCTION

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

1. Field of the Invention

This invention relates to a method for creating and editing electronic health records using touch screen monitors.

2. Description of the Related Art

The growing complexity of the healthcare system has led to the introduction of different types of computer based tools geared specifically to the healthcare sector.

Such tools include electronic health record systems which aim to upgrade the traditional paper based patient medical chart to electronic health records.

Currently, paper medical charts are often based on predefined templates.

The use of templates is encouraged for several reasons. Medical semiology, the rules regarding interpretation of patient signs and symptoms, includes stages such as documenting the patient's medical history, conducting a physical examination, establishing differential diagnoses, ordering and interpretation of lab tests and imaging exams, and deciding for a treatment plan. The use of templates streamlines this process.

Furthermore, the rules regarding reimbursement of healthcare services require that all aspects of healthcare services must be coded so that the complexity of each component of the service may be correctly valued and documented. This activity is also facilitated by the use of templates.

Additionally, the standardization of terminology and procedures, desirable in order to rationalize work and improve patient safety, is also facilitated and enhanced by the use of templates.

The use of electronic health record tools presents an opportunity to address some of the shortcomings of paper medical charts, with one such shortcoming being the difficulty in accessing paper charts across multiple locations within healthcare facilities. Another shortcoming is the difficulty in keeping records up to date. In a paper chart any update often implies crossing out or writing over the chart or even producing more paperwork, thus increasing legibility issues.

Electronic health record tools are able to overcome most of the traditional shortcomings of paper-based medical charts. Electronic systems are also able to introduce cross-check mechanisms enabling the early detection of potential harmful events such as drug-drug, drug-allergy, or drug-food interactions. For instance, electronic systems may alert a physician when a specific treatment to which the patient is allergic to is about to be prescribed, which is information introduced into the electronic health record at an earlier stage.

However, the adaptation of paper templates to an electronic environment also presents significant challenges. Up until now electronic systems and methods have not been able to successfully tackle these problems. In some cases the existing paper templates have simply been loaded as is to an electronic medium.

The challenges resulting from the adaptation of paper templates to an electronic environment are related to major differences between paper and electronic media.

One relevant challenge relates to resolution. Even though considerable progress has been made in the creation of high resolution screens, paper may still be printed at much higher resolutions. Computer screens normally display images at 72 dots per each linear inch while a normal printed paper will display images at 300 dots per each linear inch.

As a consequence of the difference in image resolution, it is not possible to include as much information on a comparable computer screen size as it is on paper.

Additionally, the aspect ratio is different. Typical paper sizes have portrait orientation for their content, while the opposite or landscape orientation is the most common for computer screens. Consequently, a creation of an electronic health record tool that merely mimics a paper version is not adequate.

Such approaches often create a significant amount of clutter, hamper readability, and generate error prone solutions. These are important issues from the human-computer interaction point of view, especially as healthcare professionals have increasingly less time to spend with each patient while, simultaneously, the quest for efficiency has dramatically increased in past years.

The relative benefit of being able to quickly review all information contained on one face of a sheet of paper cannot be successfully replicated in a computer medium, as much less information is able to be included in a computer screen. Even though it is theoretically possible to create an endless computer screen with recourse to scrolling, the user will not able to see all information at a glance.

Hence, there is a great need within the healthcare sector for a computer implemented method for creating and editing electronic health records in a readable, efficient and user friendly way.

### BRIEF SUMMARY OF THE INVENTION

The current invention is a computer implemented system and method for creating and editing electronic health records. It is directed at information technology tools for the healthcare sector that incorporate in any way an electronic health record.

The method uses touch screen monitors connected to a central processing unit. All 20 information is entered and edited with recourse to the touch screen monitor. The method may be used with desktop or wall mounted units as well as with portable units such as personal digital assistants or tablet computers.

The method also includes the division of the touch screen into virtual fields sized to match the standard human fingertip. Each field corresponds to a single data element and contains an appropriate label.

The method includes the presentation of medical documentation templates in a hierarchical structure in such a way that the user is presented with information in a sequential way in accordance with the process contained in the relevant template. The sequence covers all aspects of the medical semiological process, including the patient's medical history, the history of the present illness, the physical examination, differential diagnoses, tests and analyses, definitive diagnosis, and the treatment plan, among others.

In order to ensure that only relevant information is displayed, the method further includes the use of collapsible graphic artifacts, such as menus and windows. When a specific selection or data input has been made, the subelements retract and reveal the following step in the sequence. This use of collapsible elements which open up and collapse in the manner of an accordion vastly facilitates the readability by reducing the amount of information at any particular moment available onscreen.

The method includes the possibility of selecting data elements by touching in sequence a selected display field one, two, or three times. The sequential touches alter the information displayed in that virtual field. The first touch activates the data element indicating a positive response, for example indicating that the patient has fever. A second touch indicates a negative response, for example indicating that a patient does not have fever. The third touch resets the data element. The difference between a negative response and non-activation of the data element is relevant. In medicine, positive findings and negative findings are often of the same value.

The method further includes the possibility to assign different values to data elements wherein the activation of the field allows for the introduction of numerical values, free text, or a link to a document contained elsewhere. An example of a relevant numerical value could be the record of the body temperature of the patient.

The method further includes coding of each data element in such a way that, for each data element, a structured sentence may be created thus enhancing readability. The structured sentences are included in a summary field as the end result of the documentation process. This summary field is visible at all times in the screen view, thereby ensuring that a general view of the electronic health record is presented to the user.

The method also provides for coding of data elements in accordance with standard medical terminologies such as the Systemized Nomenclature of Medicine (SNOMED) system and the Health Level Seven, Inc. (HL7) system. The use of standard medical terminologies facilitates the integration with other software tools and databases, and allows for intelligent prompting. Intelligent prompting is achieved by exploring inconsistencies and relations of exclusivity, dependency, and synchrony within the information written into the medical template.

Prompting will adapt the process in a dynamic way, for example, by aggregating symptoms that are connected by relations of exclusivity, dependency, or synchrony. Use of different color or font size enhances and assists in intelligent prompting.

### BRIEF DESCRIPTION OF THE SEVERAL VIEWS OF THE DRAWINGS

FIG. 1 is a screen view of a display according to the present invention showing virtual fields sized to match the standard human fingertip.

FIG. 2 is a screen view of a display according to the present invention showing the hierarchical structure of the health record templates.

FIG. 3 is a screen view of a display according to the present invention showing the collapsible structure of the electronic form.

FIG. 4 is a screen view of a display according to the present invention showing the activation, introduction of a negative value, and deactivation of a data field.

FIG. 5 is a screen view of a display according to the present invention showing the field for introduction of numerical or text information.

FIG. 6 is a screen view of a display according to the present invention showing the summary field of the form.

FIG. 7 is a screen view of a display according to the present invention showing the use of intelligent prompting.

FIG. 8 is a schematic of the components for implementing the present invention.

### DETAILED DESCRIPTION OF THE INVENTION

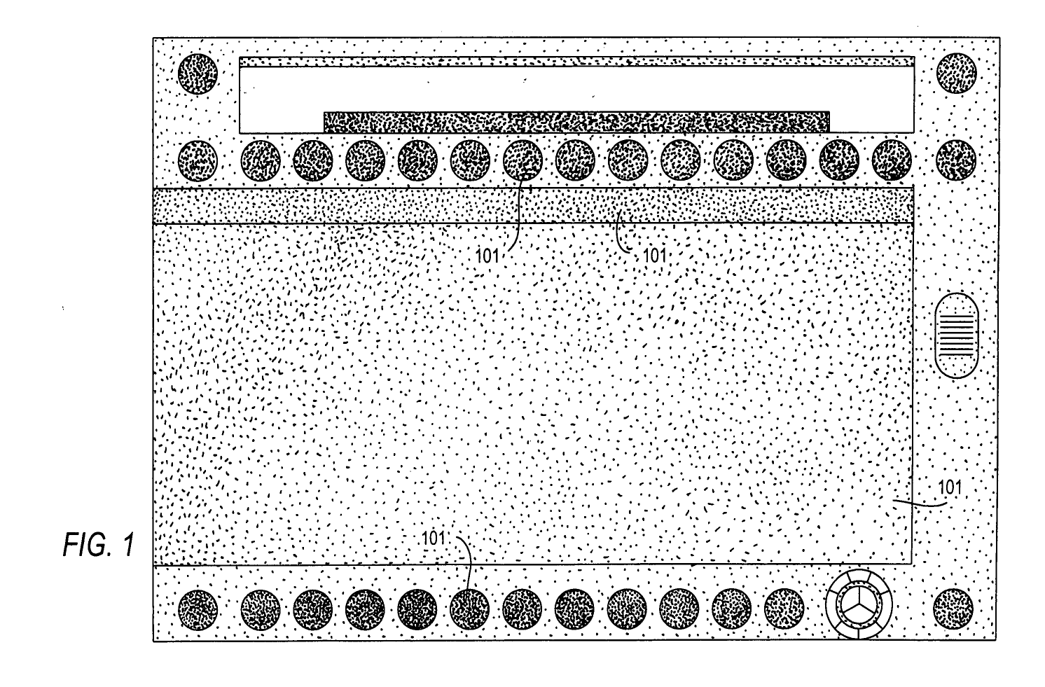

Referring to FIGS. 1-8, the present invention provides an electronic health record touch screen form entry method, in which FIG. 1 is an example of a display which is part of the graphical user interface (GUI) according to the present invention. The display is divided into a significant number of virtual fields 101. The virtual fields 101 are sized to match the size of a standard or average human fingertip; for example, about 2 cm. in width and about 2 cm. in height. In an example, embodiment, the virtual fields 101 are square shaped, but other shapes such as rectangles, other polygons, and circles, or any combination thereof, may be used. Each virtual field 101 corresponds to a single data element and contains an appropriate label or icon to identify its function.

In the preferred embodiment, activation and deactivation of the virtual fields 101 is executed by touching the screen. Activation and deactivation of the virtual fields 101 may also be executed with recourse to a pointing device connected to the monitors, such as a mouse or an electronic stylus.

The virtual fields 101 are used to navigate between displays and to manage the electronic forms.

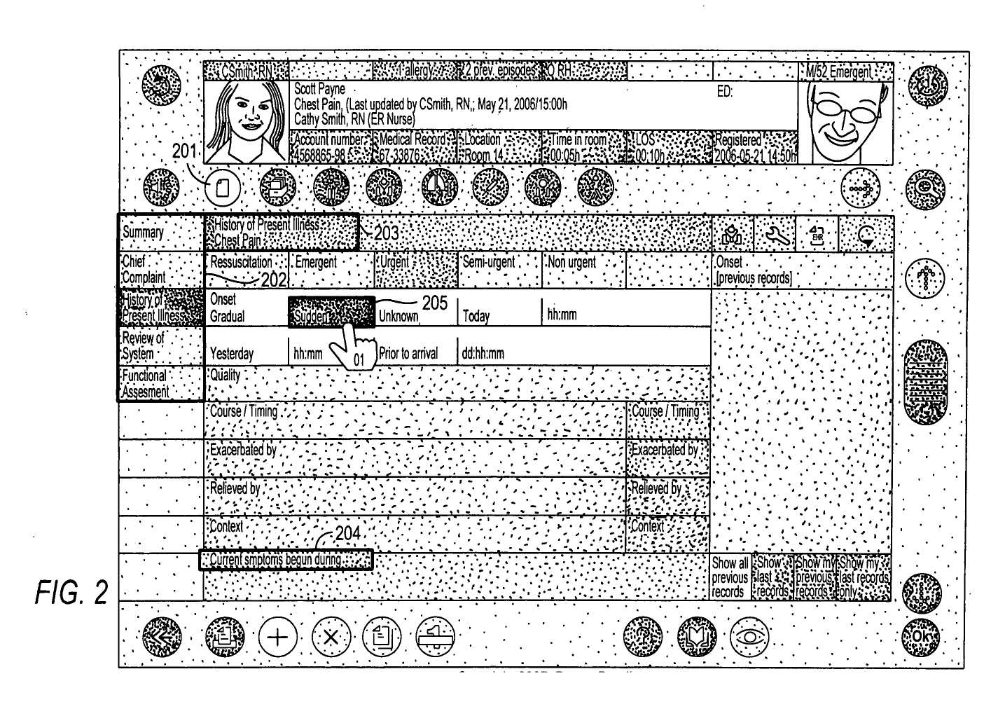

FIG. 2 is another example of a display which is part of the graphical user interface which demonstrates the hierarchical structure of the forms. This structure allows the user to be presented with information in a sequential way in accordance with the process contained in the relevant form. The sequence covers all aspects of the medical semiological process, including the patient's medical history, the history of the present illness, the physical examination, differential diagnoses, tests and analyses, definitive diagnosis, and the treatment plan, among others.

The virtual fields 201 constitute the highest hierarchical group of this form with the “History of Present Illness”, “Review of Systems” and “Functional Assessment” options. In this example the “History of Present Illness” virtual field 201 has been activated as is indicated by its dark foreground image on light background, while other virtual fields are not activated as indicated by their light foreground image on a dark background. The virtual field 202 is active as shown by light foreground text or images on a dark background, with the virtual field 202 indicating which virtual field, such as virtual field 201 ,is currently activated.

The virtual fields 203 constitute the next step in the structure with the “Onset”, “Quality”, “Course/Timing”, “Exacerbated by”, “Relieved by” and “Context”. In this example the virtual field 203 labeled “Onset” has been activated. The next step in the structure is constituted by virtual fields 204 labeled “Gradual”, “Sudden”, “Unknown”, “Today”, “Yesterday”, and “Prior to arrival”. The remaining virtual fields 203 have their own options that will be visible if activated.

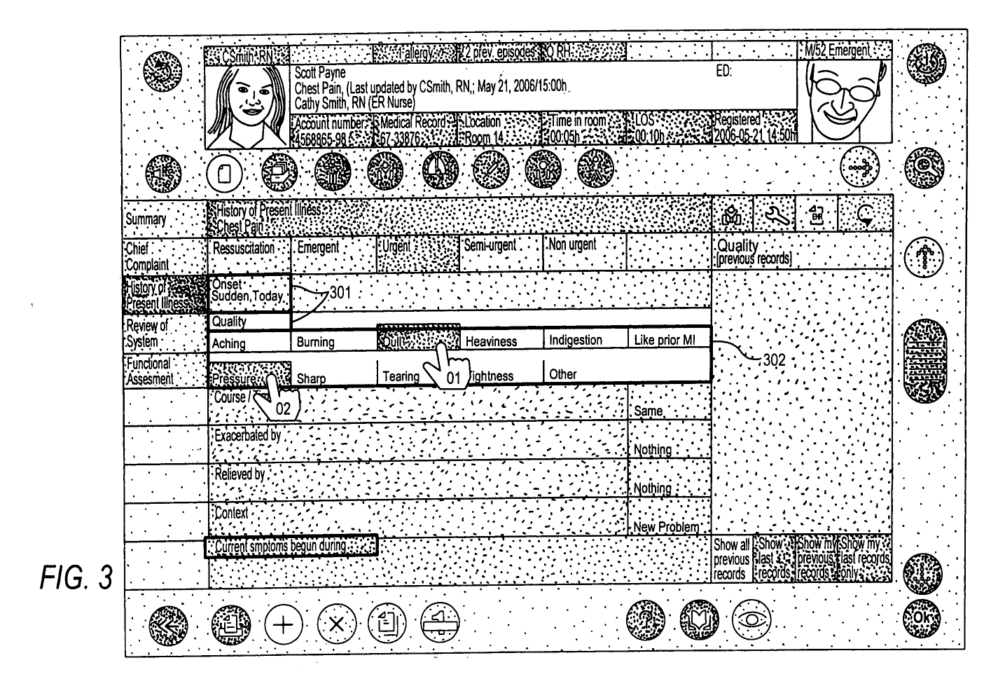

The visibility of the relevant options of groups hierarchically inferior is managed by opening and collapsing as illustrated by FIG. 3 which is a different example of a display which is part of the graphical user interface.

The use of collapsible graphic artifacts such as menus and resizable windows ensures that only relevant information is displayed at a specific time when the electronic form is being managed. After a specific selection or data input has been made, the subelements retract and reveal the following step in the sequence.

The virtual field 301 labeled “Quality” is currently activated and, as a consequence of such activation, the subfields 302 labeled “Aching”, “Burning”, “Dull”, “Heaviness”, “Indigestion”, “Like prior MI”, “Pressure”, “Sharp”, “Tearing”, “Tightness” and “Other” are open and visible.

The virtual field 301 “Onset” is not activated and as such its subfields 204 which were visible in FIG. 2 are no longer visible and/or highlighted.

This use of collapsible elements which open up and collapse in the manner of a accordion facilitates the readability by reducing the amount of information at any particular moment available onscreen.

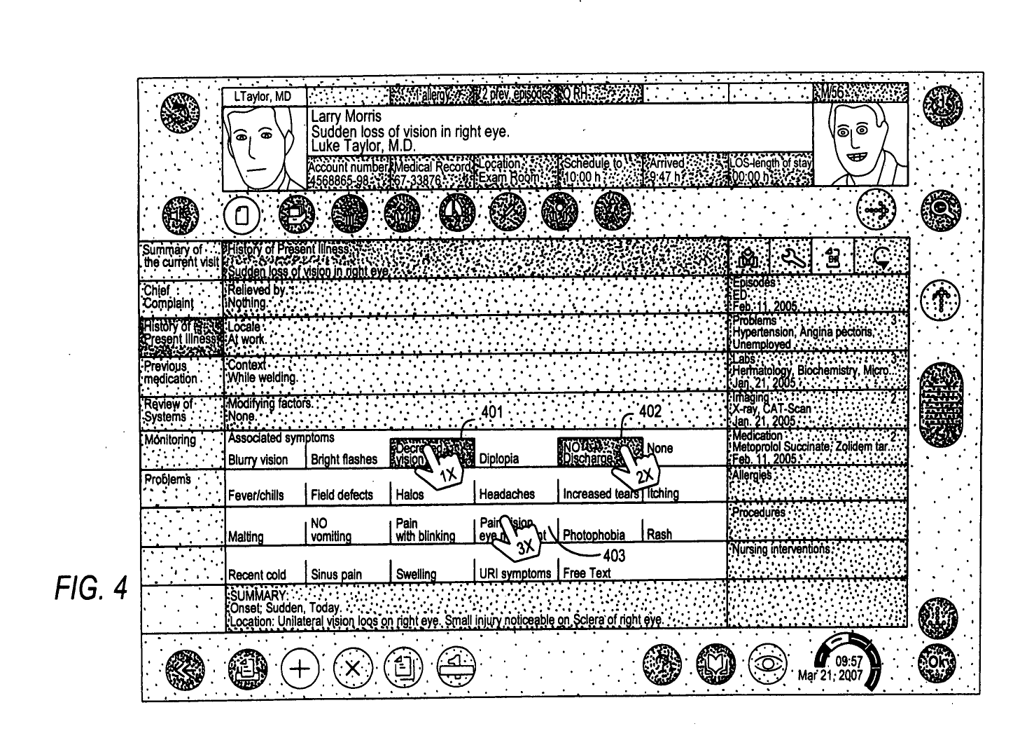

FIG. 4 is another example of a display which is part of the graphical user interface which demonstrates the possibility of selecting data elements by touching, in sequence, a selected field one, two, or three times.

The sequential touches alter the information displayed in that virtual field. The first touch activates the data element indicating a positive response. A second touch indicates a negative response. The third touch resets the data element. The difference between a negative response and non-activation of the data element is relevant. In medicine, positive findings and negative findings are often of the same value.

The virtual field 401 has been touched once and thus has been activated and indicates that the patient has “Decreased vision”. The virtual field 402 has been touched twice in sequence and has been activated and indicates that the patient has “NO Discharge”. The virtual field 403 has been touched three times in sequence and has been deactivated and indicates that the patient does not have “Photophobia”.

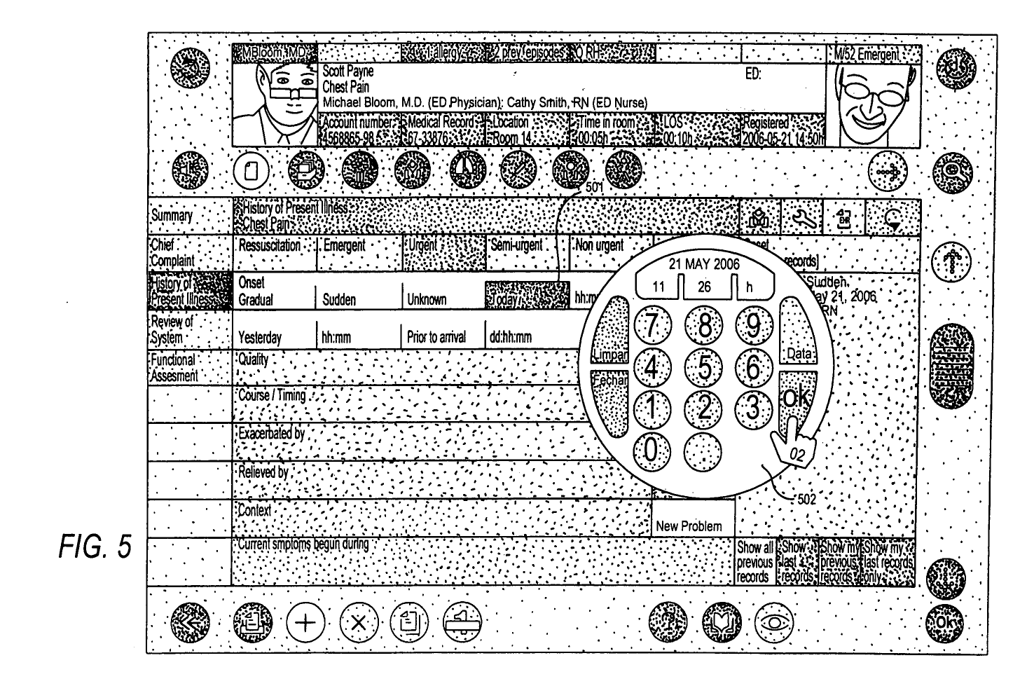

FIG. 5 is another example of a display which is part of the graphical user interface which demonstrates the possibility of assigning different values to data elements beyond the indication of a positive or negative value or the deactivation of data fields. The virtual field 501 has been activated and a new virtual field 502 has opened. The virtual field 502 displays a virtual keypad which allows the introduction of a numerical value entered by the user, such as, in this example, a body temperature reading of the patient. Activation of any virtual field could also allow for introduction of other numerical values, free text, or a link to a document contained elsewhere in the system such as images or laboratory results.

The method includes coding of each data element in such a way that, for each data element, a structured sentence may be created. This results in enhanced readability. The structured sentences are included in a summary field as the end result of the documentation process. This summary field may be visible at all times in the screen view, thereby ensuring that a general view of the electronic health record is presented to the user.

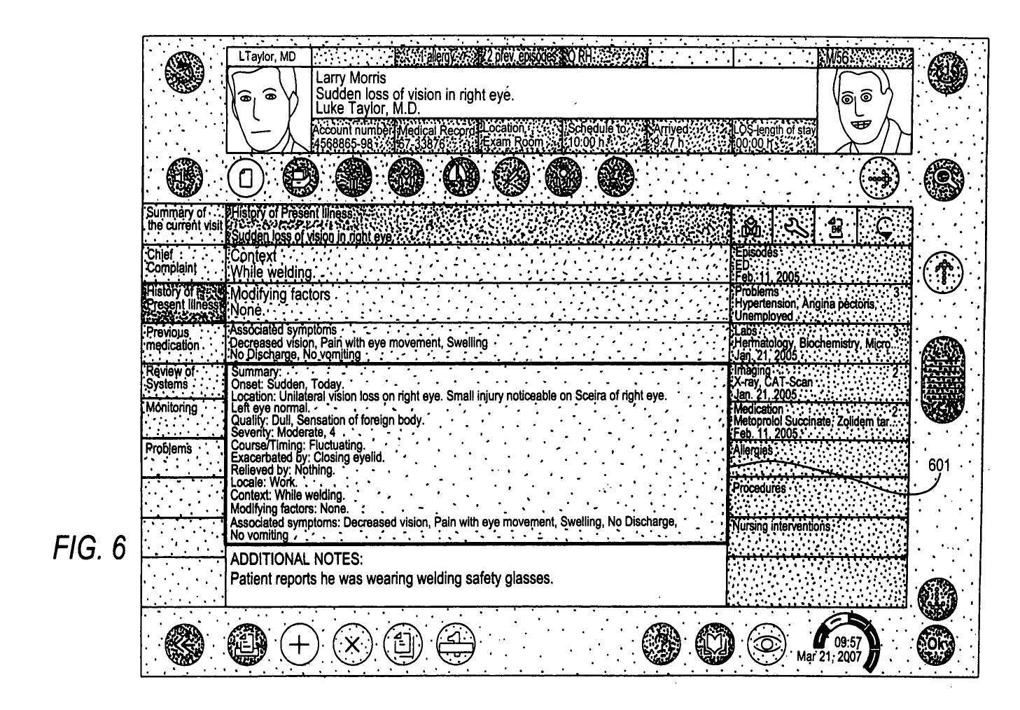

FIG. 6 is another example of a display which is part of the graphical user interface which demonstrates the summary field. The virtual data field 601 demonstrates the summary field which is created as a result of completing the electronic form.

The coding of each data element uses standard medical terminologies such as SNOMED and HL7. The use of standard medical terminologies facilitates the integration with other software tools and databases, and allows for intelligent prompting. Intelligent prompting is achieved by exploring inconsistencies and relations of exclusivity, dependency, and synchrony within the information written into the medical template.

Prompting will adapt the process in a dynamic way by aggregating symptoms that are connected by relations of exclusivity, dependency, or synchrony. Use of different color or font size enhances and assists in intelligent prompting.

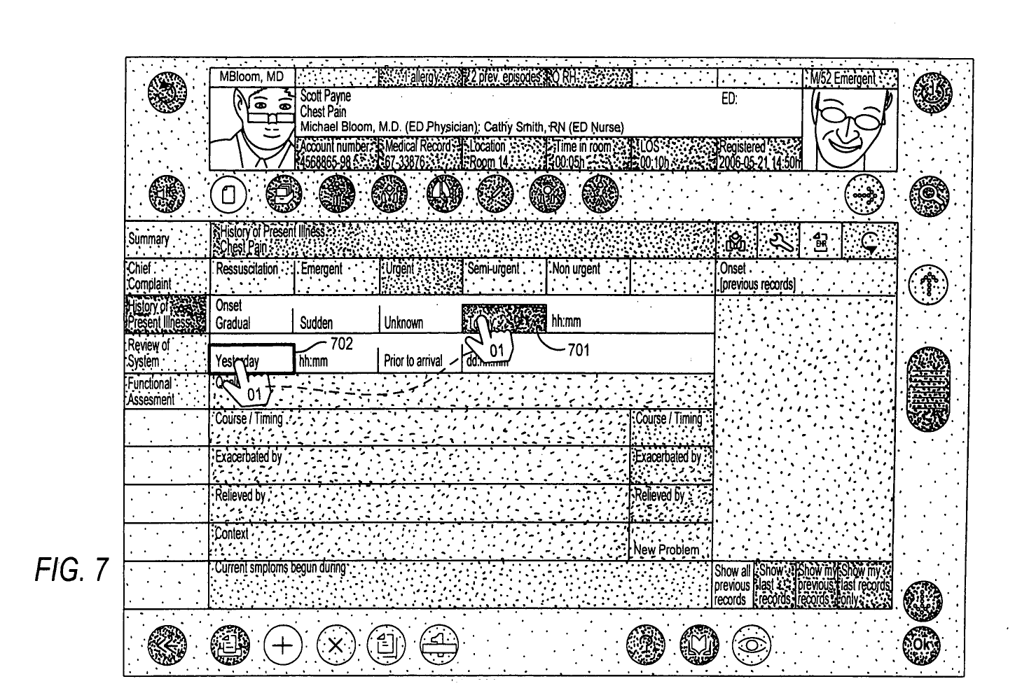

FIG. 7 is another example of a display which is part of the graphical user interface which demonstrates the use of intelligent prompting. The virtual field 701 labeled “Today” has been activated as a result of the collection of the patient's history of the present illness. As a result of the activation of the virtual field 701 labeled “Today”, the virtual field 702 labeled “Yesterday” cannot be activated as it would contradict the information inserted beforehand. The activation of the virtual field 702 labeled “Yesterday” will only be possible if virtual field 701 labeled “Today” is deactivated first.

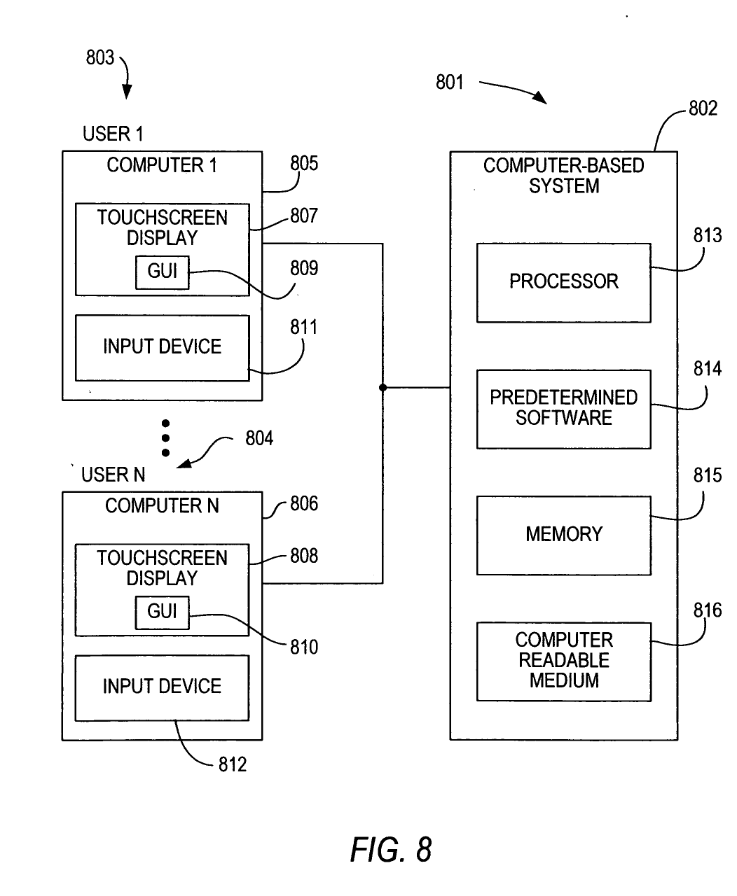

FIG. 8 illustrates an example system 801 having hardware and/or software components for implementing the present invention described herein with respect to FIGS. 1-7. The system 801 includes a computer-based system 802, such as a server or mainframe of a healthcare facility or hospital, which is accessible by a plurality of users 803, 804 through respective user computers 805, 806, respectively. Each user computer 805, 806 includes a respective touchscreen display 807, 808, which presents the GUIs 809, 810 to receive and process user inputs and to display the screens described herein and shown in FIGS. 1-7. The user computers 805, 806 may also include a respective input device 811, 812, such as a keyboard, a mouse, or other known input devices for selecting and activating or deactivating display field, and for entry of data to complement the data entry and processing through the GUIs 809, 810. In addition, the input devices 811, 812, may be connected to and/or incorporated into the GUIs 809, 810, respectively.

The computer-based system 802 includes a processor 813 such as a central processing unit (CPU) for controlling the system 801 of the present invention and for interacting and processing inputs and outputs to the user computers 803, 804 using known communication methods such as wired and/or wireless communications in a manner known in the art. Predetermined software 814 may be executed by the processor 813 to operate the computer-based system 802 to implement the present invention. A memory 815 is included for storing operating parameters and settings, such as the operating system of the computer-based system 802, as well as for storing user inputs and selections, and optionally health records used in the present invention. The memory 815 may include a database of the health records accessed and updated by the present invention.

The present invention may also include a computer readable medium 816, such as a portable memory device for installing and/or operating the present invention using the processor 813 of the computer-based system 802. The computer readable medium 816 may be accessed and read by any known computer readable medium reader, such as a disk drive or memory reader known in the art, electronically or electromagnetically connected to any computer or system 802, 803, 804 used in the present invention, such as by wired and/or wireless connections. The computer readable medium 816 may include the database of health records, and may optionally be included in the memory 815.

The computer-based system 802 may be incorporated into a single central computing environment and/or may be connected to distributed systems and accessible through networks such as the Internet and/or other known communications systems for implementation and communication with the computers 805, 806 of the users 803, 804.

According to the present invention shown in FIGS. 1-8 and described herein, a method is disclosed for creating and editing electronic health records using a touch screen monitor connected to a computer with a central processing unit, with the method including the steps of: a) dividing the touch screen into fields sized in accordance with a regular human fingertip, in which each field corresponds to a data element and contains a label; b) presenting medical documentation templates in a hierarchical structure, in which the user is presented with information in a sequential way in accordance with a process written into the electronic health record; c) providing collapsible graphic user interface (GUI) elements which, once the GUI elements have been selected, retract in an accordion-type manner; and d) receiving user selections of the data elements by the touching of the user selections by the user in sequence in the field three times, in which the first touch activates the data element indicating a positive response, the second touch indicates a negative response, and the third touch resets the data element.

The method also may include the step of activating the data element by introducing one of a numerical value, free text, or a link to a document contained elsewhere. The method also may include the step of coding each data element, in which a structured sentence is created and included in a summary field in the bottom of the computer screen, thereby ensuring that a general view of the electronic health record is present at all times. The method also may include the step of coding data elements in accordance with standard medical terminologies to allow for intelligent prompting. The method also may include the step of using relations of exclusivity, dependency, and synchrony to further automate the template completion process. A software program, embodied on a computer readable medium, may incorporate and implement the disclosed method.

What is claimed is:

1. A method for creating and editing electronic health records using a touch screen monitor connected to a computer with a central processing unit, the method comprising the steps of:
a) dividing the touch screen into fields sized in accordance with a regular human fingertip, wherein each field corresponds to a data element and contains a label;
b) presenting medical documentation templates in a hierarchical structure, wherein the user is presented with information in a sequential way in accordance with a process written into the electronic health record;
c) providing collapsible graphic user interface (GUI) elements which, once the GUI elements have been selected, retract in an accordion-type manner; and
d) receiving user selections of the data elements by the touching of the user selections by the user in sequence in the field three times, wherein the first touch activates the data element indicating a positive response, the second touch indicates a negative response, and the third touch resets the data element.

2. The method of claim 1, further comprising the step of:
activating the data element by introducing one of a numerical value, free text, or a link to a document contained elsewhere.

3. The method of claim 1, further comprising the step of:
coding each data element, wherein a structured sentence is created and included in a summary field in the bottom of the computer screen, thereby ensuring that a general view of the electronic health record is present at all times.

4. The method of claim 1, further comprising the step of:
coding data elements in accordance with standard medical terminologies to allow for intelligent prompting.

5. The method of claim 1, further comprising the step of:
using relations of exclusivity, dependency, and synchrony to further automate the template completion process.

6. A software program, embodied on a computer readable medium, incorporating the method recited in claim 1.
